(19) United States
(12) Patent Application Publication
(10) Pub. No.: US 2006/0070800 A1
(43) Pub. Date: Apr. 6, 2006

(54) Drag harness

(75) Inventors: Patricia Lewis, Tipp City, OH (US); William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(73) Assignee: Morning Pride Manufacturing, L.L.C.

(21) Appl. No.: 11/284,640

(22) Filed: Nov. 21, 2005

Related U.S. Application Data
(62) Division of application No. 10/772,560, filed on Feb. 5, 2004.

(51) Int. Cl. A62B 35/00

(52) U.S. Cl. 182/3

(57) ABSTRACT

A drag harness made from strapping, possibly a single length of strapping, comprises two arm loops of a fixed length and a drag loop of a fixed length, which is joined, as by being sewn or by being riveted, to the arm loops at a common juncture. The arm loops are made from a single length of strapping and the drag loop is made from a separate length of strapping made of a flame-resistant material. The drag loop is adapted to extend above the shoulders of the wearer and behind the head of the wearer, if the wearer is standing, whereby a rescuer grasping the drag loop can drag the wearer, via the drag harness, if the wearer is lying in a supine position. Thus, the drag grip, the common juncture, or both are adapted to support the head of the wearer, when the wearer is being dragged, via the head harness, while the wearer is lying in a supine position.

### CROSS-REFERENCE TO RELATED APPLICATION

This application is a division of U.S. patent application Ser. No. 10/772,560, which was filed on Feb. 5, 2005.

### TECHNICAL FIELD OF THE INVENTION

This invention pertains to a drag harness of a type used by a rescuer, such as a firefighter, to drag a wearer lying in a supine position, from a perilous situation.

### BACKGROUND OF THE INVENTION

Drag harnesses of the type noted above are exemplified in U.S. Pat. No. 4,682,671, No. 4,854,418, and No. 6,205,584 B1. Such harnesses, as known heretofore, tend to be somewhat uncomfortable to their wearers, principally because such harnesses, as known heretofore, have arm loops that are not stabilized and, therefore, can pinch the arms of their wearers, shift and become un-proportional, or ride down the backs of their wearers and, additionally, because such harnesses do not support the heads of their wearers, while their wearers are being dragged via such harnesses.

### SUMMARY OF THE INVENTION

This invention provides a drag harness comprising two arm loops, each of which has a fixed length and each of which is adapted to receive one arm of a wearer, and a drag grip, which is joined to the arm loops solely at a common juncture and which is adapted to extend above the shoulders of the wearer and behind the head of the wearer, if the wearer is standing.

Preferably, the drag grip is a drag loop, which has a fixed length. A rescuer grasping the drag grip with one hand or inserting one arm through the drag loop, if the drag grip is a drag loop, can drag the wearer, via the drag harness, while the wearer is lying in a supine position. Preferably, the drag grip, the common juncture, or both are adapted to support the head of the wearer, as the wearer is being dragged, via the head harness, while the wearer is lying in a supine position.

Preferably, the drag harness is made from strapping. In one contemplated embodiment, the drag harness is made from a single piece of strapping, which may be advantageously made from a flame-resistant material but which may be alternatively made from conventional strapping material. In another contemplated embodiment, in which the arm loops are made from a single piece of conventional strapping material, the drag grip is made from a separate piece of strapping, which may be advantageously made from a flame-resistant material.

### BRIEF DESCRIPTION OF THE DRAWINGS

FIG. 1 is a top view of a supine person wearing a drag harness embodying this invention and made from strapping sewn at a common juncture.

FIG. 2 is a bottom view of the supine person wearing the same harness. Further, FIGS. 1 and 2 illustrate one arm of a rescuer utilizing the drag harness to drag the supine person wearing the drag harness, head first.

FIG. 3 is a bottom view of the same harness, apart from the person.

FIG. 4 is a bottom view of the same harness, as broken away to reveal some constructional details.

FIG. 5 is a fragmentary detail of an alternate construction, in which the common juncture is riveted, rather than sewn.

### DETAILED DESCRIPTION OF THE ILLUSTRATED EMBODIMENTS

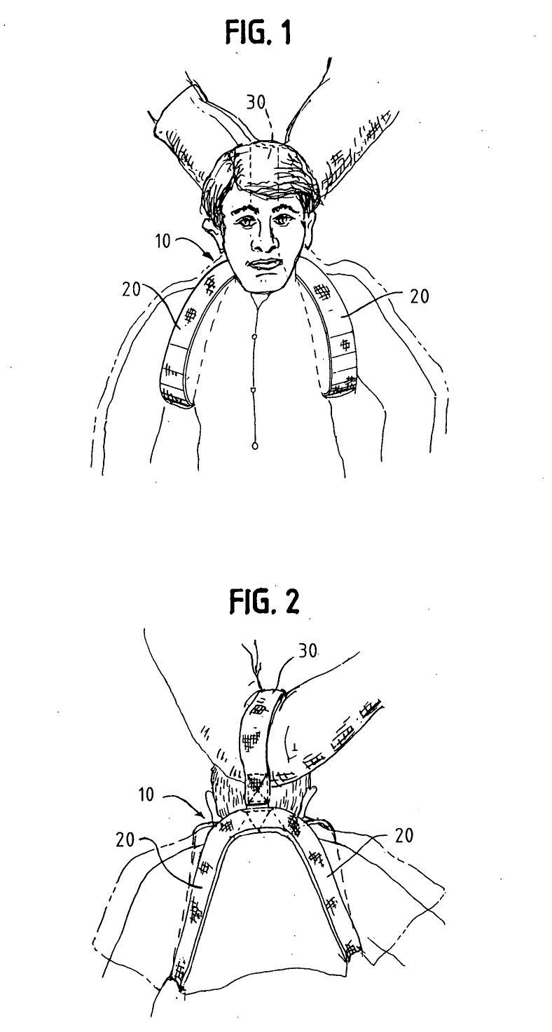

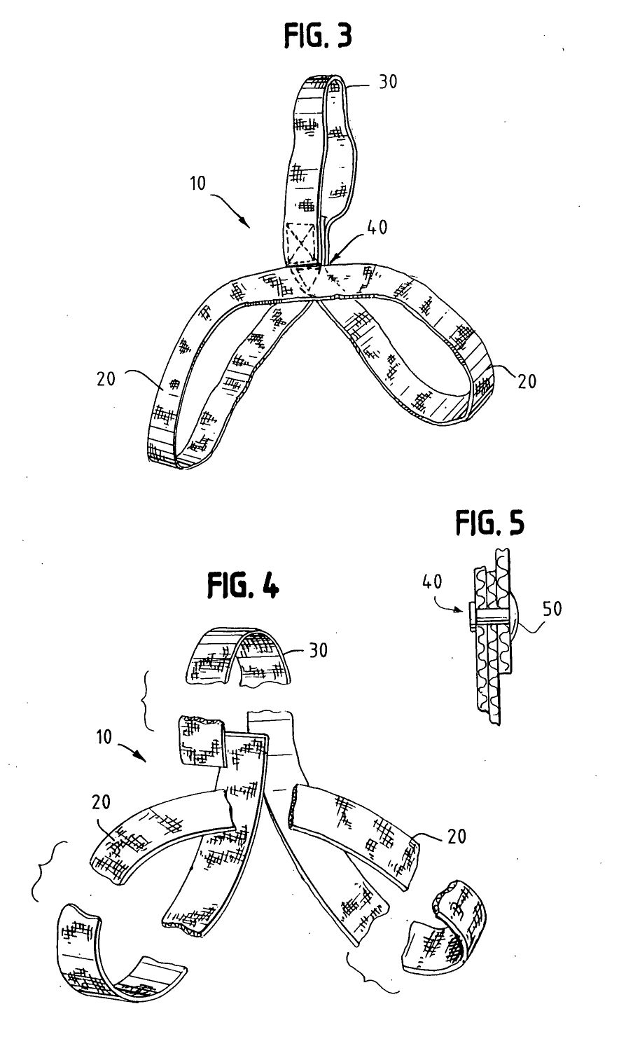

As illustrated in FIGS. 1 and 2, a drag harness 10 embodying this invention is being worn by a supine person and is being utilized by a rescuer to drag the supine person, head first. Broadly, the drag harness 10 comprises two arm loops 20 and a drag loop 30, which is joined to the arm loops 20 at a common juncture 40. Each arm loop 20 has an equal, fixed length, and the grip loop 30 has a fixed length. Preferably, as illustrated in FIGS. 2 and 3, the common juncture 40 is sewn. Alternatively, as illustrated in FIG. 5, the common juncture 40 is riveted, via one or more rivets 50.

Each arm loop 20 is adapted to receive one arm of a wearer, i.e., a person wearing the drag harness 10. The drag loop 30 is adapted to extend above the shoulders of the wearer and behind the head of the wearer, if the wearer is standing. Thus, a rescuer grasping the drag loop 30 with one hand or inserting one arm through the drag loop 30, as illustrated in FIGS. 1 and 2, can drag the wearer, via the drag harness 10, while the wearer is lying in a supine position.

Preferably, as illustrated in FIGS. 1, 2, 3, and 4, the drag harness 10 is made from strapping. In one contemplated embodiment, the drag harness 10 is made from a single piece of strapping, which may be advantageously made from a flame-resistant material, such as Nomex™ material or Kevlar™ material, but which may be alternatively made from conventional strapping material, such as nylon or leather. In another contemplated embodiment, in which the arm loops 20 are made from a single piece of conventional strapping material, such as nylon or leather, the drag loop 30 is made from a separate piece of strapping, which may be advantageously made from a flame-resistant material, such as Nomex™ material or Kevlar™ material.

Advantageously, because the arm loops 20 have fixed lengths, the arm loops 20 are stabilized and, therefore, do not end to pinch the arms of the wearer, shift and become un-proportional, or ride down the back of the wearer. Additionally, the drag grip 30, the common juncture 40, or both are adapted to support the head of the wearer, as the wearer is being dragged, via the head harness 10, while the wearer is lying in a supine position.

Advantageously, the drag harness 10 can be stowed in a pocket of a garment worn by a rescuer or can be incorporated into a garment, such as a protective coat worn by a firefighter, as drag harnesses known heretofore have been incorporated into garments.

1. A drag harness comprising two arm loops, each of which has a fixed length and is adapted to receive one arm of a wearer, and a drag grip, which is joined to the arm loops solely at a common juncture and which is adapted to extend above the shoulders of the wearer and behind the head of the wearer, if the wearer is standing, whereby a rescuer grasping the drag grip can drag the wearer, via the drag harness, if the wearer is lying in a supine position, wherein the arm loops are made from a single length of strapping and the drag grip is made from a separate piece.

2. The drag harness of claim 1, wherein the drag grip is a drag loop, which has a fixed length.

3. The drag harness of claim 1, wherein the separate piece is a separate length of strapping.

4. The drag harness of claim 2, wherein the separate piece is a separate piece of strapping.

5. The drag harness of claim 1, wherein the separate piece is made from flame-resistant material.

6. The drag harness of claim 2, wherein the separate piece is made from flame-resistant material.

7. The drag harness of claim 3, wherein the separate length of strapping is made from flame-resistant material.

8. The drag harness of claim 4, wherein the separate length of strapping is made from flame-resistant material.

9. The drag harness of any one of claims 1 through 8, wherein the drag grip, the common juncture, or both are adapted to support the head of the wearer, when the wearer is being dragged, via the head harness, while the wearer is lying in a supine position.
